(19) United States
(12) Patent Application Publication
(10) Pub. No.: US 2012/0164612 A1
(43) Pub. Date: Jun. 28, 2012

(54) IDENTIFICATION AND DETECTION OF SPEECH ERRORS IN LANGUAGE INSTRUCTION

(75) Inventors: Laurence Gillick, Newton, MA (US); Alan Schwartz, Lexington, MA (US); Jean-Manuel Van Thong, Arlington, MA (US); Peter Wolf, Winchester, MA (US); Don McAllaster, Shrewsbury, MA (US)

(73) Assignee: EnglishCentral, Inc., Lexington, MA (US)

(21) Appl. No.: 13/338,383

(22) Filed: Dec. 28, 2011

Related U.S. Application Data
(60) Provisional application No. 61/427,629, filed on Dec. 28, 2010.
(60) Provisional application No. 61/427,622, filed on Dec. 28, 2010.

(51) Int. Cl. G09B 19/04

(52) U.S. Cl. 434/185

(57) ABSTRACT

Speech errors for a learner of a language (e.g., an English language learner) are identified automatically based on aggregated characteristics of that learner's speech.

### CROSS-REFERENCE TO RELATED APPLICATIONS

This application claims the benefit of U.S. Provisional Application 61/427,629, filed on Dec. 28, 2010, and U.S. Provisional Application 61/427,622, filed on Dec. 28, 2010, which are incorporated herein by reference.

### BACKGROUND

This invention relates to automated identification and/or detection of speech errors, and in particular relates to use of such techniques in language instruction.

Automatic phoneme recognition has proven to be a difficult technical problem in the field of speech recognition. Even the best automated systems only achieve error rates between 20% and 30% on a phoneme transcription task, when they do not use word level constraints, such as limited vocabularies.

Skilled spectrogram readers have pointed out that, especially in rapid speech, there may be only the barest gesture visible in a spectrogram for a phoneme instance that humans hear clearly. To put it another way, an actual realization of an individual phoneme in continuous speech may depart dramatically from what one might take to be its ideal form. Moreover, the realization of a phoneme strongly depends on its phonemic neighborhood: namely, the phonemes that precede or follow it.

There is a need to identify speech errors made by a learner of a language. Speech errors may correspond to phonetic errors. However, as introduced above, identification of specific instances of phonetic errors is a difficult or impossible task using current technology. There is therefore a need to provide more useful information regarding phonetic-level errors than can be achieved using prior techniques.

### SUMMARY

In one aspect, in general, speech errors for a learner of a language (e.g., an English language learner) are identified automatically based on aggregated characteristics of that learner's speech.

In another aspect, in general, a method for automated processing of a user's speech in a speech training (e.g., language learning) system includes accepting a data representation (e.g., sampled and/or processed waveform data) of a user's speech. The data representation of the user's speech is processed according to a statistical model. The model has model parameters associated with each of a set of speech units. The model parameters associated with at least some of the speech units include parameters associated with target (e.g., correctly spoken and/or native speaker) instances of the speech unit and parameters associated with non-target (e.g., incorrectly spoken and/or non-native) instances of the speech unit. The processing includes determining an aggregated measure of one or more classes of speech errors in the user's speech based on the statistical model.

Other features and advantages of the invention are apparent from the following description, and from the claims.

### DRAWINGS

FIG. 1 is a system block diagram of a language learning system.

### DESCRIPTION

### 1 Overview

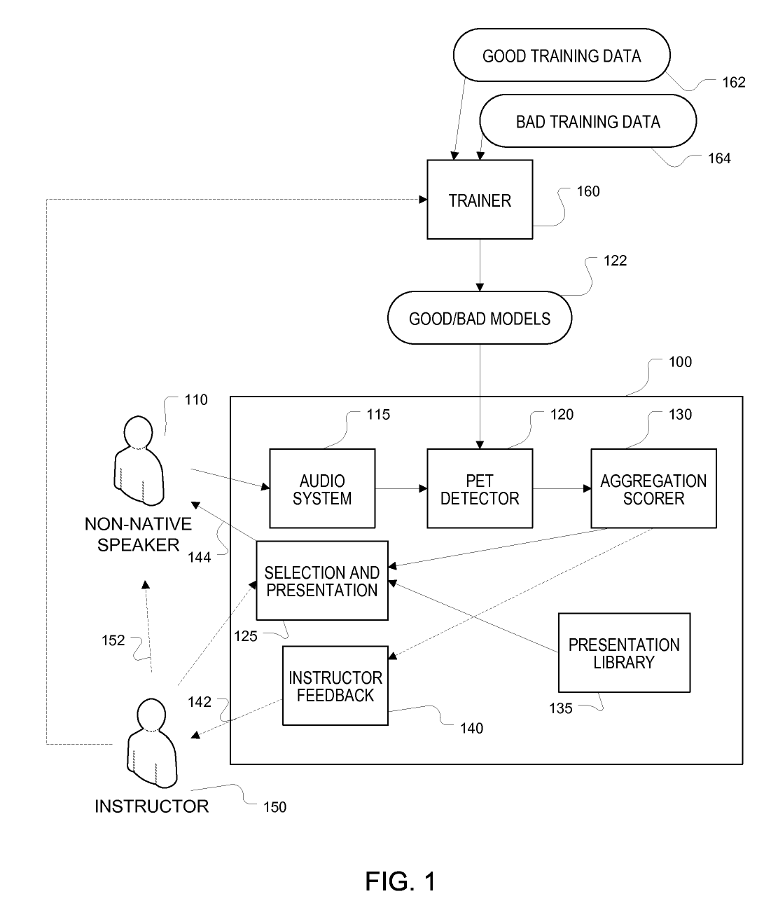

Referring to FIG. 1, one application of the techniques described below is in instruction of non-native speaker 110 of a language, for instance, a native Japanese speaker who is learning to speak English. It should be understood that the example of a non-native speaker learning English is only one example. More generally, the approaches are applicable to many scenarios where a learner desires to speak in a manner than matches target examples, which could include scenarios where the learner knows the language but is attempting to address dialect and/or regional accent issues.

A computer-based language-learning system 100 is configured to provide outputs representing prompts and/or sample media to a speaker 110 and accept speech input 124 representing the acoustic voice output from the speaker. In some embodiments, the outputs include selections from a library of presentation material 135, which includes audio or multimedia (e.g., audio and video) examples of correctly spoken examples from the target language. Such examples may include, for instance, clips from popular movies, news broadcasts, or other material that is not specifically targeted for instruction, as well as prompts and examples specifically prepared for instruction. The system 100 provides feedback 144 to the speaker and/or feedback 142 to an instructor 150 of the speaker, who may then provide instructional information 152 to the speaker, either directly or via the selection and presentation module 125. In some embodiments, the instructor 150 may also control the trainer 160 and/or the selection and presentation module 125, for example, to select training material and/or PETs that are most appropriate for the non-native learner 110. Embodiments of the system do not necessarily require an instructor, and an automated selection and presentation component 125 uses an analysis of the speaker to select and present material from the library 135 and/or the user selects the material from the library directly.

Note that the system 100 may be implemented in a number of different configurations, including as software executing on a single personal computer, or as a distributed system involving computing devices at one or more locations. In some implementations, the speech input 124 is a digital or analog signal that represents a conversion of the voice signal using devices not illustrated in FIG. 1. In some implementations, the feedback 142 and/or 144 is in the form of graphical and/or audio information provided through a computer interface, but other forms of feedback, including audio-only, printed reports, etc. are within the scope of this approach.

One function of the language learning system 100 addresses the identification of phonetic errors in the speech of the language-learning speaker 110. An implementation of this function makes use of a pronunciation error types (“PET”) detector 120, an aggregated scorer 130, and an instruction feedback module 140. Generally, as described in more detail below, the PET detector 120 makes use of speech recognition techniques to determine “soft” information regarding the speaker's ability to correctly articulate linguistic material (sounds, words, sentences, longer passages, etc.) in the target language. The aggregated scorer 130 combines information across multiple instances of particular phonetic or acoustic events to determine scores or other measures of the speaker's ability to correctly produce speech associated with those events. The instruction feedback module 140 provides a presentation of the output of the aggregated scorer as feedback to the speaker 110 and/or instructor.

One or more embodiments of a speech error identification system make use of large amounts of captured and archived speech data to form “good” (also referred to as target or native) and optionally “bad” (also referred to as learner, non-native, or background) models 122 for the target language. In some examples, the “good” models represent correct production of speech in the target language, and “bad” models represent production that is flawed, for example, in particular ways that may be representative of language learners of the particular native language being addressed. For example, the good/bad models 122 may include data determined by a trainer 160 (e.g., a statistical parameter estimation system) based on speech data 164 from native speakers and/or non-native speakers where production errors are present. In one example, the corpus has over 40 million utterances of data from non-native speakers of English, whose native language may also be identified. In some examples, also archived is information about the audio captured at the phoneme, word and sentence levels as well as captured information with each such utterance about microphone, noise level, operating system, etc. The trainer 160 also determines model for correctly produced speech (or at least speech produced by native speakers) based on acoustic training data 162. In another example, the good models are trained from native US English speech and the bad models are trained from English as spoken by non-native (e.g., Japanese) learners of English. Alternatively, the good models are training from speech of speakers whose native language is Japanese, but who have become highly fluent in English. This latter approach may be most appropriate in that the non-native speakers may aspire to reach such fluency as opposed to fully matching native English speakers.

### 2 Training

As introduced above, it is not possible to infallibly detect that an individual pronunciation error has been made by a speaker. Examples of pronunciation error types (“PET”) include one or more of phoneme production, prosodic features, or other acoustic manifestations of the realization of the speech. Although it may not be possible to detect individual pronunciation errors with high precision, the system draws aggregated conclusions about the average PET production quality of the learner based on an analysis of one or more recordings of the individual's speech. For instance, although it may be difficult to accurately classify each phoneme produced by a speaker, over the course of the reading of a known passage, the system can determine the probability or certainty (e.g., confidence) that a particular class of error is present in the speech.

There are a variety of approaches forming the models that are used to make “good” versus “bad” distinctions when analyzing the learner's speech. The selection of the technique to use is base at least in part on the type of data that is available for training. Furthermore, depending on the type of training data that is available, the nature of the statistical analysis may differ, for example, being based on a two-class hypothesis or based on a significance test approach. A non-exhaustive set of alternative approaches to training include the following:
Data from non-native speakers of the language is used for both “good” and “bad” models, with marking of the data being used to determine whether instances of phonemes should contribute to the “good” or the “bad” model. In some examples, the marking is manually determined at the phoneme, word, sentence, passage, and/or speaker level. In some examples, the marking is grossly based on intelligibility rather than according to specific articulation or phonetic features. In some examples, the marking is made at least partially automatically, for example, by bootstrapping using manually marked data.
Data from target speakers is used for “good” models, and data from non-native speakers is used for “bad” models. In some examples, only manually and/or automatically marked instances are used for the “bad” models, for example, so that well produced instances are not included in the training of the bad models.
Data from target speakers is used for “good” models, and deviation from “good” models is measured.

As introduced above, in one embodiment, training of the statistical detector for PETs begins by carefully labeling a body of training data which includes speech from people with a given language background (for example, Japanese speakers) who are learning a new language (say, English). The labels mark good and bad instances of phonemes, as determined by a skilled listener. In some embodiments, we represent the speech data using signal processing that is typically used in speech recognition (for example, involving the computation of Cepstral features at fixed time intervals). We then build models for the good instances and the bad instances, again using the sorts of methods developed in the speech recognition literature: for example, Gaussian mixture models.

One approach to representing the information regarding good versus bad production of a particular phoneme is to make use of a statistical model (e.g., a Hidden Markov Model) for good instances of that phoneme, and a model for bad instances for that phoneme. In some alternative embodiments, there may be multiple models for different classes of good examples and/or for bad examples. In some alternative embodiments, the models may be further refined, for example, based on phonetic context, or models may be based on different units, such as syllables, phoneme pairs, etc.

Various training approaches can be used. For example, “good” models may be produced independently of the “bad” models, using respective training corpora. In other examples, discriminative training approaches are used to produce models that are tailored to the task of discriminating between the good and the bad classes. One form or model makes use of Gaussian distributions of processed speech parameters (e.g., Cepstra), and various forms for models (e.g., single Gaussians, mixture distributions, etc.) may be used. In other examples, other forms of models, for example, based on Neural Networks, are used.

Note that in different versions of the system, different definitions of “bad” may be used. In some versions, truly unintelligible instances of phonemes are deemed bad, while strongly accented instances are deemed good. In some versions, strongly accented instances may also be considered “bad”.

In some examples, a “bad” model may account for substitution-type errors. For example, one error may comprise uttering “S” when a “SH” would be correct. Therefore, the “bad” model may also include characterizations of substitutions in addition or instead of characterizing general bad versions of “SH”.

In some examples, none or not all the training data is carefully labeled, and an automated procedure is used to train the good and bad models based on unlabelled training speech. In some embodiments, some or all of the training data has aggregated labeling, for example, at an utterance or passage level. For example, a training utterance may be labeled by a teacher of English as having a binary label for or a degree (e.g., on a 0 to 10 point scale, or a “weak,” “average,” “strong” scale) related to presence of a particular PET, for example, a score of 2 on proper pronunciation of “r”. However, the utterance may not be labeled to identify which instances of “r” are improperly uttered. Such training is nevertheless valuable because, for instance, the specific instances of “r” errors may be treated as hidden or missing variables in a statistical training procedure.

A variety of techniques may be used to identify the set of PETs that is considered by the system. For example, a set of typical errors may be known and documented in teaching manuals for a particular target language. Automated techniques may also be used to identify the error types, for example, by identifying phonemes or phonemes in particular contexts that have statistically significant numbers of instances in a non-native corpus that do not match native speaker models sufficiently. Such automated identification of the set of PETs that will be considered can be important when there is inadequate knowledge of learners' problems in the target language. In some examples, the automatic identification of PETs is performed on a subset of training data that is marked as unintelligible by a human listener evaluating the data. In some implementations, a set of candidate errors are determined by linguistic rules and then data is used to determine whether those candidate errors are in fact made in the training data.

### 3 PET Detection

The PET detector 120 makes use of these trained models to detect and/or numerically characterize instances of speech events, such as instances of particular phonemes (e.g., phonemes, phonemes in particular contexts, etc.). Detection of a PET (also referred to as an “alert” below) is an example of speech recognition but, in this application, in general, we know the sequence of words to be spoken (e.g., because the speaker is reading or repeating predetermined words), but we do not know whether the speaker will say the bad version of particular phonemes or the good version. Naturally, the quality of a phoneme or prosodic feature spoken can extend from a notion of good versus bad to a numerical scale of quality scores, ranging from 0 to 10, say.

Processing of the speech sample from the learning speaker can be understood first by considering a single PET in the passage spoken. Assuming we know the identity of the PET had it been spoken correctly, for example, based on a forced alignment of the speech with a known corresponding text, the good versus bad models can be used to make a binary statistical decision as to whether the given instance is good or bad, using a statistical measure (e.g., likelihood ratio, odds, probability of good, etc.) that can be determined from the models. Let us now suppose that we have used such a statistical “detector” for the phoneme p. The detector triggers whenever it thinks that the realization of p is a poor one. Let X[i]=1 if the detector triggers on the i^{th} instance of a phoneme p in a particular learner's recorded speech. Otherwise, X[i]=0. Sometimes, the detector will falsely trigger on good instances of p. Other times, it will not trigger on bad instances of p. There are, thus, two kinds of errors: false alerts and misses. The expected value of X[i] is the probability of an alert, P(alert). Note that P(alert)=P(good p)P(false alert|good p)+P(bad p)P(alert|bad p).

If we suppose (quite reasonably) that the probability of a false alert given a good instance of p is smaller than the probability of a true alert given a bad instance of p, then as the proportion of bad p's increases, P(alert) will also increase.

There is a tradeoff between the two kinds of errors. At one extreme, we may choose to label every instance of a phoneme as bad, in which case there will be no misses, but the false alert rate will be 1. At the other extreme, we may never label an instance as bad, in which case the miss rate will be 1, but the false alert rate will be 0. One approach is to choose an operating point along this continuum. One way to choose the operating point is to evaluate the relative costs of the two kinds of errors and then choose the point where the expected cost is minimized. More specifically we might choose the operating point to minimize the following expression:

E(cost)=P(good p)P(fa|good p)Cost(fa)+P(bad p)P(miss|bad p)Cost(miss).

Choosing the operating point amounts to choosing a point on the curve that relates the false alarm rate to the miss rate (sometimes referred to as a Receiver Operating Characteristic (ROC) curve), and rather than choosing the point according to an estimated cost, the point may be selected according to a criterion based on the false alarm rate or probability or the miss rate or probability. Once this point has been chosen, we have specified the behavior of the detector—namely, when it will trigger an alert.

### 4 Aggregated Scoring

In one approach, a confidence interval approach can be used to decide whether the learner has a problem with that phoneme. Generally, the approach involves converting an observed alert rate to a range representing the estimate of the probability (e.g., as a Bernoulli process probability) for that speaker. Generally, the more examples of the phoneme being analyzed, the smaller the range (i.e., the more precise the estimate) of the estimated probability. The endpoints of the range are then converted to percentiles based on data from the learner population (i.e., the peer population of the learner). In that way, we can characterize how someone is doing at realizing a particular phoneme by reference to the learner's peer group. More specifically, we can compute percentiles as follows. Choose at random a large number of speakers from the from a particular language background, say Japanese. Compute the alert rate for each phoneme for each speaker, based on a large number of examples. Use that distribution of alert rates to convert an alert rate for the speaker using the system to a percentile. This percentile provides a measure of how that speaker compares to his peer group as a whole. When there aren't very many examples of the phoneme being analyzed, we represent the uncertainty of the alert rate estimate by constructing a confidence interval for the number or rate, for example, based on a binomial probability assumption. The endpoints of the confidence interval are converted to a percentile range.

In some examples, a threshold percentile for the production of a phoneme by the group is determined by a human (e.g., teacher) listening to the data. For example, a teacher may determine that the 48^{th} percentile speaker (according to their alert rate) corresponds to a threshold quality of production of the phoneme.

Based on the ability of the aggregated scorer to construct a confidence interval for the alert rate in the speaker's data (e.g., using the binomial model and the limited samples of good and bad events), the system can determine when it has accumulated a sufficient number of alerts to be confident the alert rate is high enough so that the learner has a substantial problem with the PET. In order to determine when the observed alert rate is sufficiently high to warrant feedback from the system, we associate the alert rate with the evaluations of experienced ESL teachers (or other skilled listeners). In some embodiments, we ask several skilled listeners to evaluate the quality of the phoneme production (say, of the phoneme p) for a random collection of system users. Each speaker was rated as “strong,” “average,” or “weak” in their production quality. Generally speaking, higher alert rates were associated with weaker evaluations by the skilled listeners. Thresholds were separately determined for each phoneme of pedagogical importance, so that it was very likely that if the alert rate was above a certain threshold T, then a skilled listener would rate the speaker as “weak.” Conversely, it was quite unlikely that if the observed alert rate was above T, that the speaker would be rated as “strong” by a skilled listener.

An alternative approach to this problem does not necessarily involve any human assessments. We simply identify the phonemes for which there are triphone speech states whose realizations strongly differ between native speakers versus non-native language learners. We can then give feedback to individual learners based on their percentiles. Percentile cutoffs can be arbitrary—we are basically “grading on a curve”—ensuring that we achieve a certain “grade” distribution. Once we know the learner's percentile range with sufficient precision (say, that he is somewhere between the 85th and the 95th percentile in the way that he says the phoneme r), we can assign him a suitable grade.

Alternatively, we can also evaluate the learner's performance with respect to that of a native US English speaker. For an advanced learner, if we cannot statistically distinguish his performance from that of a native speaker, then clearly his pronunciation has reached the target.

In another approach, rather that using the binary detections of alerts, “soft” quantities, referred to as scores, are used. For example, the scores are log likelihood ratios of good versus bad model (or other monotonic functions of such log likelihood ratio). The scores are accumulated, for example, by simple summation of the log likelihood ratios. In other examples, percentile approaches are used to normalize the scores, for example, to according to the observed scores over the speaker's peer population. After accumulation, the accumulated scores may also be normalized according to the distribution from the peer population. In effectively the same manner that we can compute a confidence interval for an alert rate as described above, we can compute a confidence interval for the average score difference (between good and bad models) for a given speaker's realizations of a phoneme. The endpoints of that confidence interval can be converted to percentiles, as is done for alert rates.

### 5 Automated Feedback

In some versions of the system, after identifying a statistically significant error present in a learner's speech, or if there is an indication that there is an error that is not yet statistically significant, the system automatically selects material from the library to present to the user that has a relatively high number of instances of that phoneme. This both provides the learner with positive examples to hear and learn from, and also provides the learner with practice in producing those phonemes correctly. This approach also provides further data that increases the statistical significance of the determination of whether the learner is having difficulty with that particular phoneme.

In some example, the automated feedback explicitly provides indications to the learner of the error types that they are exhibiting. Optionally a degree (e.g., 0 to 10 scale) of error or an indication of improvement that they are making as provided as the provide further output.

### 6 Instructor Feedback

Generally, the instructor feedback module provides feedback to the speaker and/or the instructor of the speaker. An aspect of this feedback relates when and how to present an error to the speaker or instructor. For example, it may not be useful to provide an exhaustive list of scores for different errors as feedback. One reason is that such a list may not focus on the most important errors. The second reason is that some errors may have so few instances that the score provided by the aggregated scorer is not significant.

In some embodiments, the detector based on statistically trained models provides a percentile or a range of percentiles (e.g., a confidence interval) that related the new speech to the range of quality of the training data. For example, a percentile of 75% may relate to the new speech corresponding to a quality better than 75% of the training data on that PET. In some embodiments, such a percentile or percentile range is then mapped to a grade or scale as provided by teachers.

In some embodiments, a teacher's ability to grade speakers is measured by the relationship of the grades provided by the teacher and machine generated grades. For example, such an approach may identify that a particular teacher is poorly skilled at detecting or grading a particular PET by finding a mismatch between the grades provided by the teacher and those provided by the system.

In some embodiments, a speaker's performance is tracked to identify if he is improving a particular PET. As with scoring on an absolute scale, or as a percentile, a confidence measurement technique is applicable to declare improvement only when there are sufficient examples to be confident of the improvement.

### 7 Example

In an example of the approach described above, suppose the speaker in instructed to speak the phrase “Really fine work” This phrase line can be mapped to a sequence of phonemes, with possible silences in between words.

[sil] r iy l iy [sil] f ay n w er k [sil]

An alignment algorithm is used to decide exactly which frames of the recording are assigned to each phoneme, for example, with each frame being computed every 10 ms. The model used to perform the alignment is trained from the appropriate examples of student speech (e.g., Japanese students of English, etc.).

An example of the start and end frame number for each phoneme or silence segment, as determined by the aligner is as follows:
[sil] 0 14
r 15 22
iy 23 28
l 29 44
etc.

Each speech segment above is then scored against the appropriate good and bad models, as described above. So, for example, the phoneme “r” lasted from frame 15 to frame 22. Each of those 8 frames is given a score by both the good model and the bad model for “r.” Let S=S_{good}·S_{bad}, the difference between the good and bad scores for a given frame. A score for the segment is obtained by averaging the 8 values of S: call that S̅.

Each phoneme has an associated score threshold. In particular, the phoneme r might have the threshold Sₜₕᵣ, which is based on the ROC curve for that phoneme (as discussed above).

If S_{bar}<Sₜₕᵣ, then we issue an “alert” for this phoneme instance. The threshold is set so as to ensure that the probability of false alerts is sufficiently small. If we aggregate (over time) the results for all instances of the phoneme “r”—we can compute the observed “alert” probability. Call that \hat{p}. This is an instance of a binomial proportion. We can construct a confidence interval for the true binomial proportion in a variety of ways. The true proportion constitutes a measure of the speaker's ability to properly pronounce the phoneme r. A well-known method (due to Wilson) for computing a confidence interval for p works fairly well even for small sample sizes (the sample size being the number of spoken instances of the given phoneme.)

We can declare ourselves to be “confident” that a student has a problem with the phoneme r, when the confidence interval for the alert probability p for r is both sufficiently narrow and sufficiently far from 0, so that the possible values are all large enough. At that point, the UI informs the student that he should work on his pronunciation of r.

An alternative embodiment would involve the direct use of the average score S̅, instead of the 0-1 binary observation as to whether there is an alert or not. As before, a confidence interval can be constructed for the long run mean value for the scores for the given phoneme.

### 8 User Interface

In some embodiments, the system provides a user interface for the speaker and/or a teacher of the speaker. For example, once we have determined that the user's alert rate is substantially higher than what we would expect from a person whose pronunciation of the phoneme is satisfactory, the UI provides further guidance to the user to enable him to learn how to realize the given phoneme more accurately. For example, he may be shown videos demonstrating the proper lip movements, proper durations, etc.

As the user continues to practice, it is to be anticipated that the quality of his pronunciations will improve over time. We may use the cumulative alert rate over time as a means of tracking his performance and providing further feedback. There are many ways to implement such a strategy. For example, if we record the proportion of alerts in every batch of 100 examples, we can then compute a regression in which we predict the P(alert) as a function of the amount of practice that has been undertaken. The slope of the corresponding regression may be used as an indicator of the rate of progress of the learner. Feedback can be implemented via a UI that lets the user know about his progress or lack thereof. Additional instructional materials may be suggested to the user depending on the measured improvement. Note that the feedback in the UI may be at one or more levels, including aggregated over all types of errors, by classes or error (e.g., “L” followed by a stop consonant), or by specific error. In some examples, the selection of errors presented may be based on whether there is statistically significant evidence that is sufficient to justify providing feedback to the user for those errors.

A large negative change in the alert rate (especially if observed across multiple phonemes) may well suggest a problem with the recording conditions: excessive noise, poor microphone placement, etc. The user's attention can be drawn to potential problems of this sort via the UI.

Although the previous discussion has been based on the idea of providing feedback to the user on the quality of his realizations of individual PETs, related ideas can be applied to other types of pronunciation feedback. It is important for a language learner to use correct prosody if he is to be intelligible. This would include using proper stress, intonation, and rhythm. For example, the user could be informed when he has put the lexical stress in the wrong place. Of course, the lexical stress detector will sometimes make a mistake—and so, again, the notion of aggregative feedback makes use of the concept that we can accumulate evidence and provide feedback based on the aggregated data even though our detectors are inevitably errorful. In some embodiments, the system addresses prosodic errors manifested by pauses in the speech. For example, good and bad durations of pauses (e.g., inter-word pauses, intra-word pauses) or good and bad durations of phonemes or words may be modeled based on the speech corpora. Then, using effectively the same techniques for aggregation of scores or alert described above, score or alerts for such prosodic errors are determined by the system, and if significant presented as feedback.

### 9 Implementations

The approaches described above may be implemented in software, in hardware, or a combination of software and hardware. The software may include instructions tangibly stored on computer readable media for execution on one or more computers. The hardware can include special purpose circuitry for performing some of the tasks. The one or more computers can form a client and server architecture, for example, with the speaker and/or the instructor having separate client computers that communicate (e.g., over a wide area or local area data network) with a server computer that implements some of the functions. In some examples, the speaker's voice data is passed over a data network or a telecommunication network.

It is to be understood that the foregoing description is intended to illustrate and not to limit the scope of the invention. Other embodiments are within the scope of the following claims.

What is claimed is:

1. A method for automated processing of a user's speech in a speech training system, the method comprising:
accepting a data representation of a user's speech; and
processing the data representation of the user's speech according to a statistical model, said model comprising model parameters associated with each of a plurality of speech units, the model parameters associated with at least some of the speech units including parameters associated with target instances of the speech unit and parameters associated with non-target instances of the speech unit;
wherein the processing includes determining an aggregated measure of one or more classes of speech errors in the user's speech based on the statistical model.

2. The method of claim 1 wherein the user's speech comprises a word sequence known prior to the processing according to the statistical model.

3. The method of claim 1 wherein the user's speech comprises a word sequence determined during the processing according to the statistical model.

4. The method of claim 1 wherein the speech units comprise phonemes.

5. The method of claim 1 wherein the speech units comprise words.

6. The method of claim 1 wherein the aggregated measure comprises a confidence measure associated with the speaker exhibiting a class of speech errors.

7. The method of claim 1 wherein determining the aggregated measure of a class of speech error includes accumulating contributions to the measure from a plurality of phonetic instances in the user's speech.

8. The method of claim 7 wherein the one or more classes of speech errors includes incorrect utterances of a first phoneme, and wherein the aggregated measure of incorrect utterance of that first phoneme is accumulated over multiple instances of the first phoneme in the user's speech.

9. The method of claim 7 wherein the accumulating of contributions includes accumulating quantities representing binary decisions of correct versus incorrect for each of the instances.

10. The method of claim 1 further comprising:
selecting material for presentation to the user based on the determined aggregate measure; and
soliciting user's speech using the selected material.

11. A speech training system comprising:
an input for accepting a data representation of a user's speech;
a storage for a statistical model, said model comprising model parameters associated with each of a plurality of speech units, the model parameters associated with at least some of the speech units including parameters associated with target instances of the speech unit and parameters associated with non-target instances of the speech unit;
a processor for processing the data representation of the user's speech according to the statistical model, the processor being configured to determine an aggregated measure of one or more classes of speech errors based on the statistical model.

12. The system of claim 11 further comprising a selection module coupled to a library for storing presentation content, the selection module being configured to select content from said library for presentation to the user based on the determined aggregate measure for the one or more classes of speech errors.

13. Software comprising a tangible machine readable medium having instructions stored thereon for causing a data processing system to:
accept a data representation of a user's speech; and
process the data representation of the user's speech according to a statistical model, said model comprising model parameters associated with each of a plurality of speech units, the model parameters associated with at least some of the speech units including parameters associated with target instances of the speech unit and parameters associated with non-target instances of the speech unit;
wherein the processing includes determining an aggregated measure of one or more classes of speech errors in the user's speech based on the statistical model.
